(19) United States
(12) Patent Application Publication
(10) Pub. No.: US 2007/0260684 A1
(43) Pub. Date: Nov. 8, 2007

(54) MANAGING CONFERENCE CALL PARTICIPANTS IN A ROSTER

(76) Inventors: Heeral Roy Sharma, San Jose, CA (US); Randall B. Baird, Austin, TX (US)

Correspondence Address: SCHWEGMAN, LUNDBERG & WOESSNER, P.A., P.O. BOX 2938, MINNEAPOLIS, MN, 55402, US

(21) Appl. No.: 11/381,963

(22) Filed: May 5, 2006

(51) Int. Cl. G06F 15/16

(52) U.S. Cl. 709/204

(57) ABSTRACT

This document discusses, among other things, systems and methods for managing a conference room roster. A method identifies a meeting participant. The method determines whether the meeting participant is associated with a meeting location and if the meeting participant is associated with the meeting location, provides an indication of the association on a computer display.

### FIELD

This patent document pertains generally to a method and system for organizing meeting participants, and more particularly, but not by way of limitation, to managing a roster of conference call participants.

### BACKGROUND

As businesses and organizations continue to grow, using technology to enable long-distance collaboration becomes increasingly more important. Traditionally, solutions involving conference calling are limited to voice communication. With the introduction of the Internet, web-based solutions enabled co-workers and customers to interact in virtual meetings using rich-format media, such as presentations, video, and interactive whiteboards. However, regardless of what technology is used to provide conferencing, the remote nature of conference calls and online meetings highlights the problem of being unable to ascertain the identity of all of the participants in attendance. Furthermore, when a person is talking or using a shared interactive resource (e.g., a virtual whiteboard) the other people in remote locations may not be able to immediately identify the speaker or presenter.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates an example of a networked environment.

FIG. 2 is a flowchart illustrating generally a method of managing conference participants.

FIG. 3 illustrates an example of an initial user interface that may be presented to a user.

FIG. 4 illustrates an example of a user interface that may be used to join a meeting as a conference room.

FIG. 5 is an example user interface after four people have joined a meeting.

FIG. 6 is a flowchart illustrating generally a method of associating a meeting participant with a conference room.

FIG. 7 is a flowchart illustrating generally a method of determining who the active speaker is in a conference call.

FIG. 8 is an example user interface showing the state of the conference call participants at some point in time.

FIG. 9 illustrates a diagrammatic representation of a machine capable of performing the systems and methods described herein.

FIG. 10 is a schematic diagram illustrating an exemplary sound processing system capable of receiving and analyzing a voice sample.

### DETAILED DESCRIPTION

The following detailed description includes references to the accompanying drawings, which form a part of the detailed description. The drawings show, by way of illustration, specific embodiments in which the invention may be practiced. These example embodiments, which are also referred to herein as “examples,” are described in enough detail to enable those skilled in the art to practice the invention. The example embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated.

### Introduction

Example embodiments allow grouping meeting participants based on their location to facilitate maintaining accurate rosters. In this detailed description, a networked environment is described by way of example; however, similar systems and methods could be used in stand-alone environments.

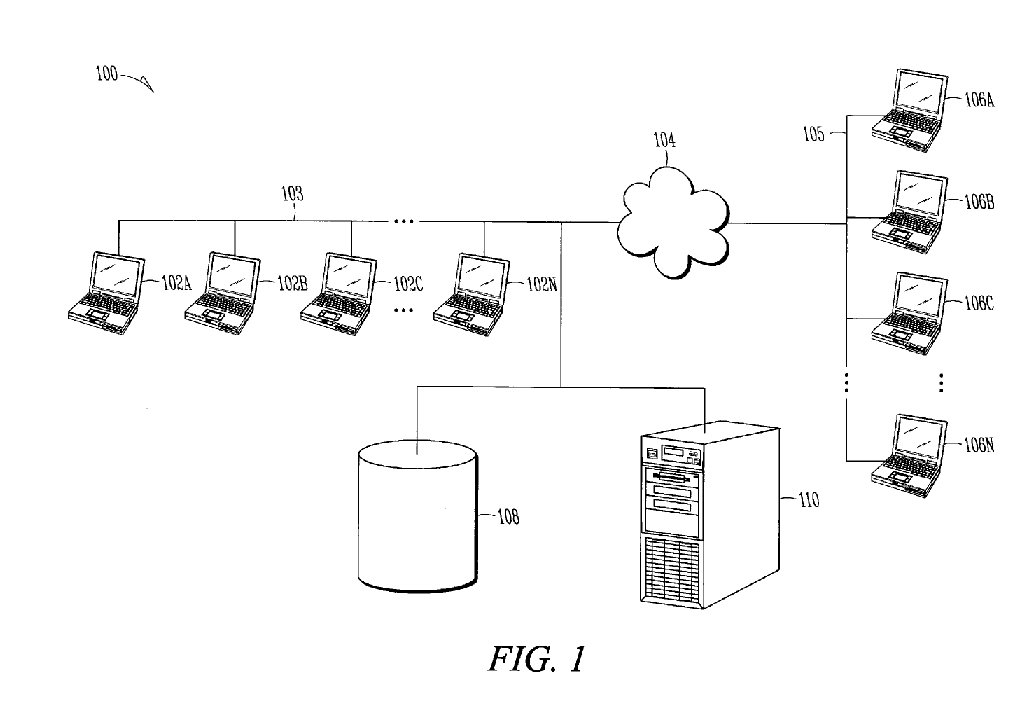

FIG. 1 illustrates an example of a networked environment 100. A group of local computer or client workstations 102A, 102B, 102C, . . . , 102N are connected in a local area network (LAN) 103. In this example, the LAN 103 is connected to an external network 104, which could be the Internet, a satellite connection, a wireless network(s), or any other network(s). In addition, a wide area network (WAN) 105 is provided comprising a group of remote computer or client workstations 106A, 106B, 106C, 106N connected to the external network 104. The external network 104 may include wired or wireless computer data networking and telephonic networking. The LAN 103 is also connected to a database server 108 and a network server 110. In certain examples, the network server 110 includes one or more collaboration applications (e.g., Cisco MeetingPlace). One or more local client workstations 102 or remote client workstations 106 are able to connect to the network server 110 to use the one or more collaboration applications. In certain examples, the database server 108 includes one or more database management systems (DBMS) (e.g., Microsoft SQL Server, Oracle), which are used to enable the example systems and methods described below.

To provide conferencing, local computer or client workstations 102A, 102B, 102C, . . . , 102N and remote computer or client workstations 106A, 106B, 106C, . . . , 106N may be communicatively coupled to a conference end point (not shown). Conference end points can include devices such as microphones, personal digital assistants, video conferencing stations, telephonic devices (e.g., a cellular telephone), or specialized computers and/or software systems. In an alternative embodiment, one or more conference end points may be directly or indirectly connected to the external network 104 to provide communication to the other conference end points.

### Example Embodiments

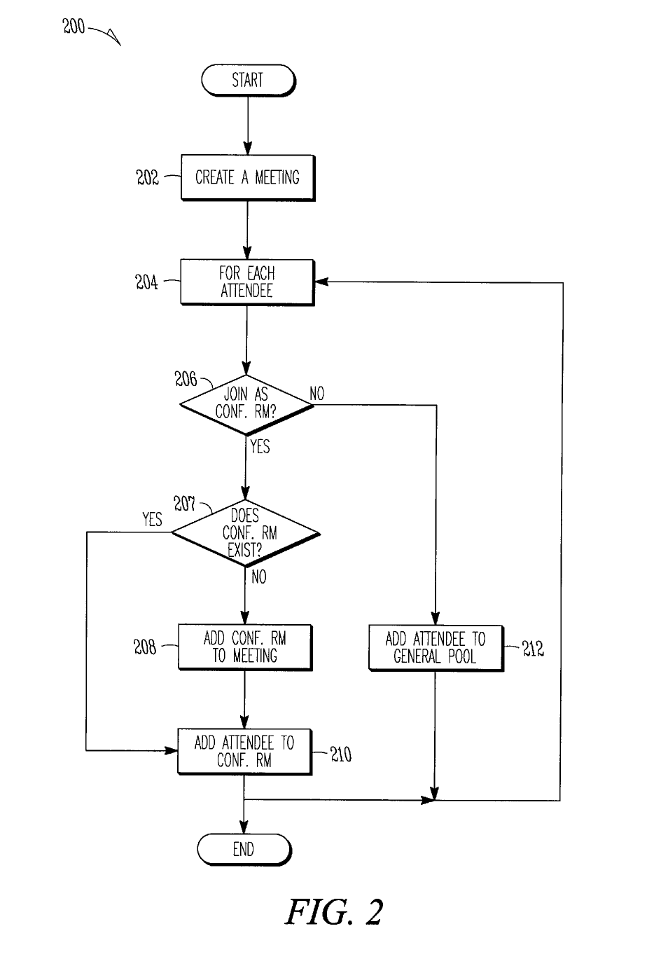

FIG. 2 is a flowchart illustrating generally a method 200 of managing conference participants. At 202, a user creates a meeting. For example, the user can create a meeting using collaboration software, such as MeetingPlace Express. After the meeting is created, invitations that include a method of connecting to the meeting (e.g., a web URL) are forwarded to each invitee. In certain examples, the user, acting as a “meeting organizer,” may have particular administrative powers, such as securing the meeting using passwords or other methods, inviting participants, removing participants, or disbanding the meeting. Additionally, the meeting organizer may be able to assign certain duties or reassign the role of the meeting organizer to another meeting attendee.

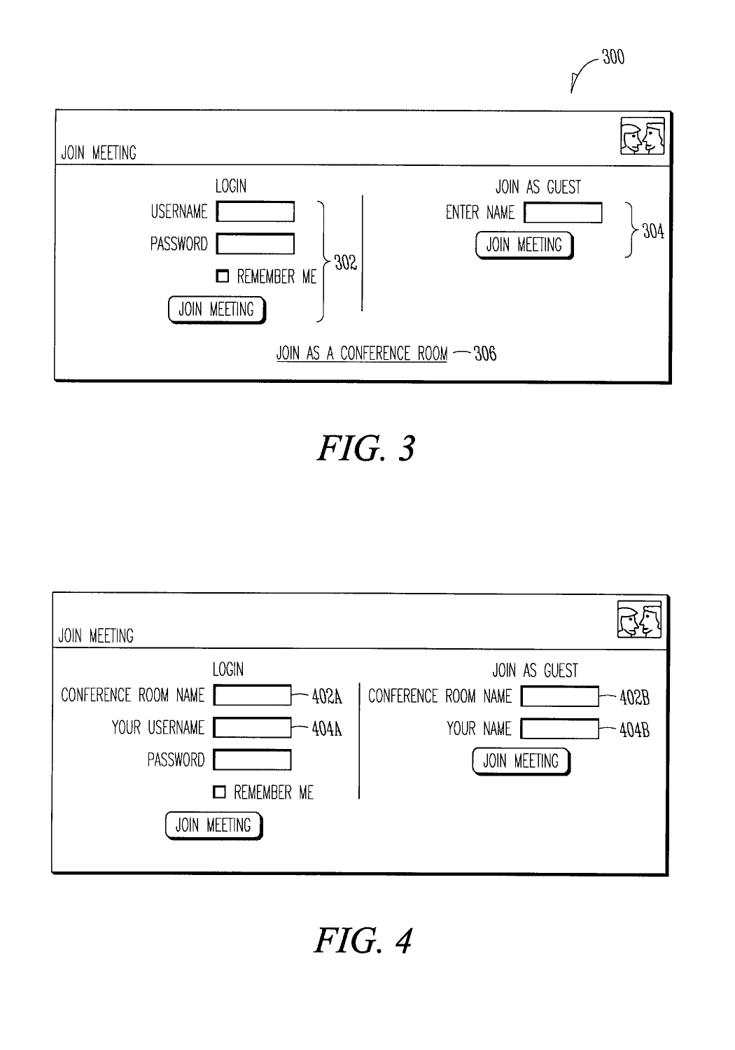

At 204, as attendees connect to the meeting using client software, each one must make a choice of how to join. In an example, an attendee uses client software to connect to a meeting server. The attendee may first indicate which meeting she would like to attend, such as by using a specific web URL or by choosing a meeting from a list of available meetings. The user may then be presented with an interface giving her the ability to join the meeting or create a conference room. FIG. 3 illustrates an example of an initial user interface 300 that may be presented to a user. In this example, a user can provide login information using the controls 302, join the meeting as a guest using controls 304, or join the meeting as a conference room using the link 306. In other examples, a user, such as a meeting organizer, can provide information that identifies another meeting participant, effectively adding the meeting participant to the roster. This flexibility in operation may help to maintain a conference room roster's integrity and ensure completeness.

Returning to FIG. 2, at 206, the method 200 may then determine if the attendee has indicated whether she wishes to join the meeting as a conference room. If the attendee indicates that she should join as a conference room, then at 207 the method 200 checks whether the conference room has already been added to the meeting. If the conference room already exists in the meeting, then the attendee is notified and the method proceeds to step 210. If the conference room has not been added to the meeting, then at 208, information about the conference room is collected and the conference room is added. In an example embodiment, the information indicating the conference room is reflected in a shared user interface. This will be discussed in more detail below. In an example embodiment, when an attendee wishes to join as a conference room, they may provide a name or description of the conference room in addition to their own login information. FIG. 4 illustrates an example of a user interface 400 that may be used to join a meeting as a conference room. In this example, a user is provided controls 402A, 402B to supply pertinent information about the conference room, along with controls 404A, 404B to supply his information.

At 210, the attendee joins the meeting and is related to the conference room that he created. In an example, the attendee's name is shown indented or in some other way related to the conference room that they created in a shared user interface. This may provide an easy way for other attendees to determine which attendees are in which conference rooms.

At 212, if the attendee chose not to join the meeting as a conference room, then their login information is captured and the attendee is not initially related to any conference room in the shared user interface. In an example, the attendee is placed in an area in the shared user interface that indicates a “general pool” of unassigned participants or participants attending outside of a conference room.

In one example embodiment, the attendee names are grouped and displayed into a hierarchical tree. The hierarchical tree may, for example, consist of one or more rosters and sub-rosters. For example, the roster comprising the top level of the hierarchy may consist of conference rooms and the lower levels (e.g., sub-rosters) may consist of attendees or participants. In another example, the top level can comprise of voice connections and lower levels can comprise of participants associated with the voice connection. In a further example, the top-most level of the hierarchy may consist of broader locations, such as a city (e.g., New York Office) or a building (e.g., Building F); one or more intermediate levels may describe office locations (e.g., Downtown Office) or conference rooms; and the lowest level of the hierarchy may comprise individual or groups of participants.

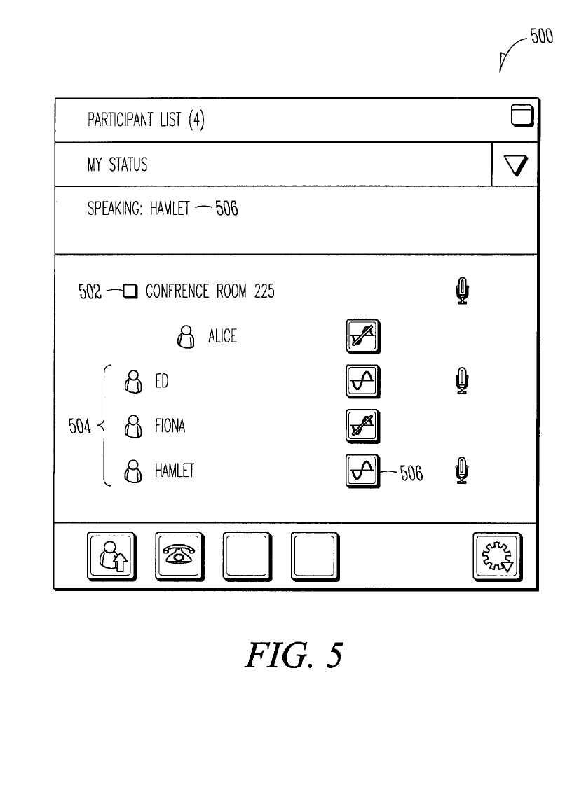

FIG. 5 is an example user interface 500 after four people have joined a meeting. In this example, Alice is shown to have joined the meeting as a conference room, “Conference Room 225,” 502 and is shown as being in the conference room in the sub-roster of the conference room. Ed, Fiona, and Hamlet are shown by way of example to have all joined the meeting as individual participants and are grouped in the general or unassigned pool 504. It may however be that Ed, Fiona, and Hamlet are in one or more conference rooms, but that they have not been associated with the conference room yet. Alternatively, the unassigned participants may be unassociated with a conference room, such as when an individual connects from a remote location (e.g., a hotel room or a home office). When this is the case, individuals may choose to connect and be placed in the general unassigned pool 504 or they may choose to create a conference room and name it appropriately to indicate their location. For example, a user connecting from a home office may choose to create a conference room named “Hamlet's Home Office.” The user Hamlet could then semi-automatically or optionally automatically, without human intervention, is associated with the personalized conference room and the user interface 500 would then be updated to reflect this association by displaying Hamlet in the personalized conference room's sub-roster. After each meeting participant has joined the meeting, certain actions can cause an automatic or semi-automatic update of the user interface 500 to indicate which participants are associated with which conference rooms.

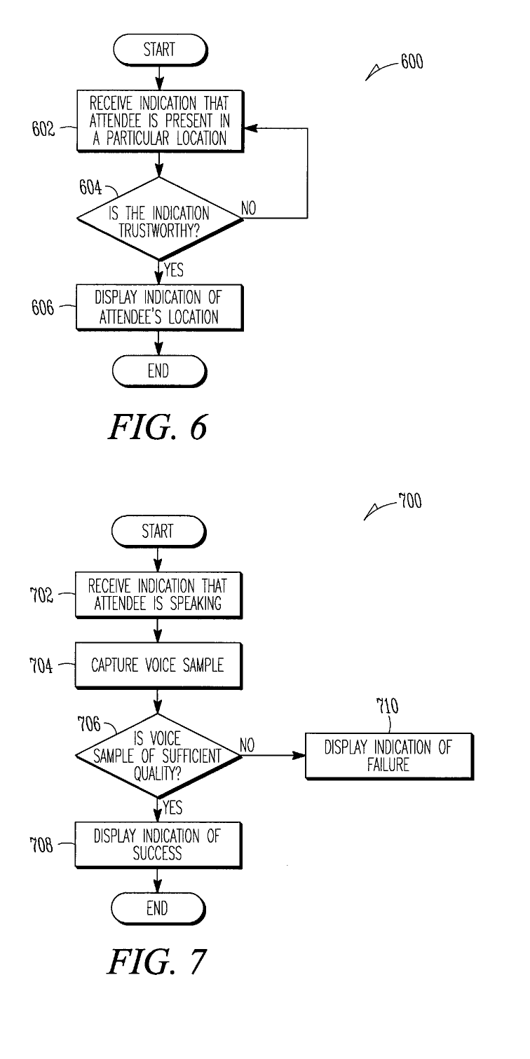

FIG. 6 is a flowchart illustrating generally an example method 600 of associating a meeting participant with a conference room. At 602, an indication that an attendee is present in a particular location (e.g., a conference room) is received. In an example embodiment, the indication can be a result of a participant's action, such as pressing a keystroke on a keyboard, providing a mouse action (e.g., left and right click simultaneously), or a voice command. The keystroke, mouse action, or voice command can then be traced to its source and, using prior knowledge, a participant's location may be determined. For example, when a participant issues a keyboard command, their computer's network address may be determined and based on information, such as an access point's IP address, a correlating conference room or other physical location can be determined. In an example embodiment, the indication may be provided by another user, such as a conference room manager, who provides the indication that the participant is present in the conference room. The conference room manager may, for example, click and drag the participant's name to the conference room in the shared user interface, thereby “filing” or associating the participant with the conference room. In another example, the conference room manager may have access to a special user interface that allows her to manage the associations of the participants in the general pool and the participants in her conference room.

In other examples, the indication is a combination of indications. For example, when a meeting participant speaks, a voice channel is activated. The active voice channel can be used in conjunction with another indication, such as a keyboard or mouse action, to provide a combined indication of the active speaker's location and identity. In such an example, the active voice channel can be used to determine a meeting participant's location and the keyboard or mouse action can be used to determine the meeting participant's identity. Alternatively, the method 600 may use voice recognition to determine the active speaker's identity. In some examples, the secondary indication, e.g., keyboard or mouse action, is provided by another meeting participant other than the active speaker. This flexibility can allow those meeting participants that don't have a computer available to be identified and associated with a location to display to other participants.

Optionally, at 604 the indication is evaluated for its trustworthiness. If the indication is provided using a manual method, such as by clicking and dragging the participant's name and icon, then the evaluation may not be necessary. However, with certain methods, such as voice recognition, a proper identification may be necessary before associating a participant with a conference room. With voice recognition, for example, if a voice sample is not clear, overlaps with another voice or audio signal, or does not contain enough information to make a positive match, the method 600 may not automatically associate the participant with a conference room.

At 606, if the indication is verified, then the shared user interface is updated to reflect the new status of the moved participant. In an example embodiment, the association is provided by grouping attendees in a sub-roster depicting a relationship to a conference room. The method 600 can be reused to reassign a meeting participant when he moves or when he was incorrectly associated with a location. For example, if Alice moves to another conference room, then the method 600 can detect 602 a new indication of her location and provided it is trustworthy, update 606 the shared user interface to reflect her new status.

In an example embodiment, the shared user interface 500, as illustrated by way of example in FIG. 5, is shared among all those in attendance. For example, in a conference call that provides voice and Internet conferencing, each person may have an individual computer to view the Internet portion (e.g., presentation or whiteboard). These users could then access the shared user interface 500 using their computers. In an example embodiment, the user interface 500 is only viewable by the conference room manager.

In other examples, another use of the shared user interface is to provide the participants an indication of who is currently speaking or in control. For example, referring to FIG. 5, when Alice speaks, the shared user interface 500 may change to indicate that Alice is the current speaker. Alice's name could for example be highlighted, set to a different color, or changed to a different font. Other techniques may be used to highlight Alice as the current speaker. An icon could appear or change next to her name or her name could appear in a special area 506 of the user interface.

FIG. 7 is a flowchart illustrating generally an example method 700 of determining who the active speaker is in a conference call. At 702, an indication is received that an attendee is speaking. In an example, the indication is a manual interaction, such as a keystroke or mouse action. For example, when Fiona speaks, she could indicate to the other participants that she is the current speaker by holding down the space bar. As long as the space bar is held down, display of her name could be changed or an icon could be used as discussed above to indicate that she is the person speaking. In another example, the indication is provided by another meeting participant, other than the active speaker. For example, Alice can provide the indication that Fiona is speaking by using a user interface element, such as a keystroke or mouse action. In an example, the indication is an automatic or semi-automatic interaction, such as by using a voice print. In general, if a voice sample has previously been recorded and is available, the active speaker's voice could be captured and compared to a database of voice prints to determine if the speaker is a known user. In such a case, the prior knowledge is used to accurately identify the speaker and the user interface is updated to reflect this.

At 704, a voice sample of the current speaker is captured. It may be preferable to only attempt to capture a voice sample when a manual indication is supplied by the current speaker. This may provide for a cleaner sample as the speaker can control when the sample is taken. In a busy conference room, there may be side conversations or other speakers that disrupt or interfere with the process of capturing a clean sample of the speaker's voice. In an example, the sample is captured only if it is the loudest signal available.

At 706, the voice sample may be analyzed for quality. The sample could be of insufficient quality for several reasons including insufficient length of the recorded sample, excess background noise, or signal corruption. If the voice sample is below a threshold of quality needed to ensure future voice matching, then at 710, the sample may be discarded and an indication of failure may be displayed on the shared user interface 500. If the sample is found to be of sufficient quality, then it may be associated with the participant, stored, and an indication of success is displayed.

For example, assume Hamlet decides to speak and has not spoken before. During his vocal contribution, he or another participant may provide an indication that he is the active speaker by pressing an iconic button on the example user interface 500. The method 700 can capture his voice sample and determine that it is a good sample. The method 700 then provides 712 an indication of the successful voice capture, such as by displaying a popup window to Hamlet that the voice capture was successful and changing an icon 506 on the shared user interface 500 to indicate that Hamlet's voice sample, as captured in step 704, has been successfully detected and stored such that the stored voice sample is associated with the contributing participant (i.e., Hamlet). The association between the stored voice sample and the participant can then be used at a later time, for example, to identify Hamlet as the active speaker. Because the stored voice sample has acoustic characteristics that are specific to the time, location, and environment from which it was sampled, matching the voice of the participant with the stored voice sample is greatly increased during the same conference call in which the sample was captured. Contemporaneous storage and matching may be advantageous because voice samples can be rendered useless in a later setting where the environmental acoustics can dramatically change voice signals.

In an example, a voice sample is captured during an initial phase of a conference call, such as during a roll call. The roll call can provide an initial association between a speaker and a location. During roll call, each meeting participant can provide a short verbal statement, such as “Hello, this is Alice speaking.” A method, such as the one described above in FIG. 7, can capture the voice sample and determine that it is of sufficient quality. At the same time, the voice channel on which the voice sample is captured is noted. This voice channel may previously have been associated with a particular location, thereby providing an indication that Alice is present in a particular location in accordance with the method 600, as described above. The method 600 can use the indication to update the shared user interface and display Alice's association with the location that corresponds to the active voice channel.

In one embodiment, once a participant has been initially identified and has been associated with a particular location, the participant may again speak, this time without the use of any additional input indicating that it is she who is speaking. The characteristics of the participant's speech may then be compared with the samples that were captured using the method 700. If a positive match is detected, the shared user interface may then be updated to indicate that the participant associated with the matching voice sample is speaking.

In some examples, a voice match may fail. In such a case, when a participant who cannot be identified with a voice match is speaking, the shared user interface can indicate the source of the voice signal at a general level (e.g., a meeting location or a conference room) using the active voice channel. For example, if during the roll call, Alice's voice sample was not captured with sufficient quality to specifically identify her on subsequent occasions, an active voice channel can be detected and mapped to an associated location and the shared user interface can display an indication of her location, such as by highlighting the conference room name with which she is associated. In an example, one or more loudest channels are identified as active voice channels. For example, when Alice and Ed are talking at the same time, both speakers can be displayed as active speakers.

In an example embodiment, the voice sample is captured locally (e.g., on the user's machine) by client software. In an example embodiment, the voice sample is carried over a voice network and captured at a central location (e.g., a server) for later analysis. The analysis may, for example, be performed locally or at a central location. In some examples, the voice sample is stored after it is captured for use at later meetings.

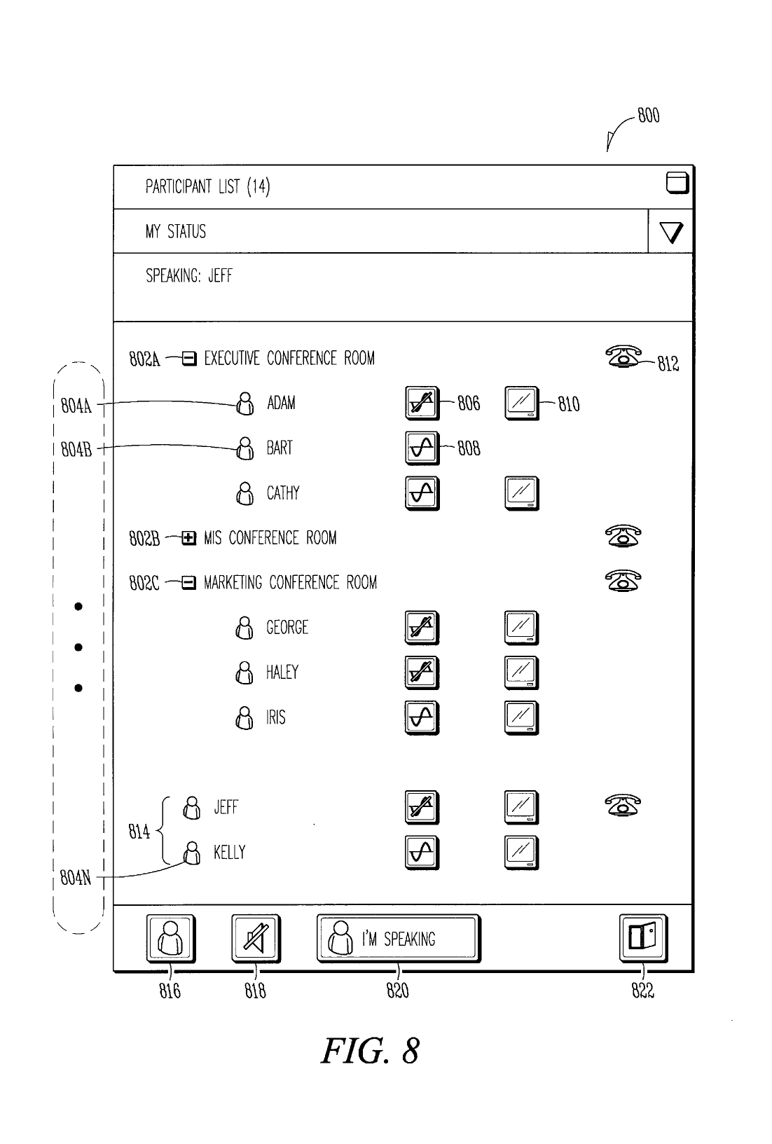

FIG. 8 is an example user interface 800 showing the state of the conference call participants at some point in time. In this example, three conference rooms have been created: “Executive Conference Room” 802A, “MIS Conference Room” 802B, and “Marketing Conference Room” 802C. Conference rooms 802A and 802C are shown in an expanded state, while conference room 802B is shown in a collapsed state. In an example, user may expand or collapse the conference room view using the ‘+’ and ‘−’ icons located near the conference room name. In other examples, the conference room views can be expanded and collapsed using other methods, such as by double clicking on the conference room name or using a context-sensitive menu.

In this example, the conference call participants 804A, 804B, . . . , 804N are grouped under a conference room name if they are associated with the conference room or left in the general pool 814. In this example, the general pool 814 is indicated by providing the attendee's name left-justified to the user interface 800. In other examples, the general pool may be shown as a separate group under a generic name, such as “Unassigned” or “General Pool.” In such an example, the list of those participants that are unassigned to a specific conference room may be expanded and collapsed in a similar fashion as described above.

In this example embodiment, icons are used to indicate the status of various conference call features. For example, a “no voiceprint” icon 806 is used to show that the attendee does not have a voice voiceprint captured. This may be the case when an attendee has chosen not to speak yet during a conference call or when a voice sample was obtained but found deficient for some reason. The waveform icon 808 is used to show that a voice sample has been detected and is associated with the attendee. A monitor screen icon 810 is used to indicate that an attendee has a display personally available, such as by using a personal computer. The absence of the monitor screen icon 810 may indicate that a person is calling in from a remote location (e.g., using a cell phone or hotel phone without a networked computer available) or that the person is in the conference room, but does not have a computer available. In this example, the final indicator icon is the phone icon 812. The phone icon 812 can be used to indicate that a person or conference room has voice capability. The icon can also be used to indicate whether a speaker is available. In this example, the presence of a phone icon 812 indicates that each of the conference rooms 802A, 802B, 802C has a community microphone and speaker available. In some examples, more than one microphone or speaker is used in a conference room. In addition, when an individual connects to the conference call, they may also have a phone icon 812 to indicate that telephonic capability is available. Telephonic capability may be provided by a traditional land line phone, cellular phone, voice over IP, or other forms of telecommunication. In other example embodiments, more or fewer icons or indications can be used to further specify a condition or status of a person, a service, or other elements.

In addition to the indication icons, one or more control icons may be provided. In this example, an “add user” icon 816 is available on the user interface 800. Activating or clicking on the add user icon 816 may bring up a secondary window that allows the user to input a name of the added user. In an example, the newly added conference call participant's name is added to the general pool 814. In another example, the secondary window may allow the user to indicate where to place the new user. The add user capability may be useful when a participant does not have access to the shared user interface 800, such as when a person does not have a computer available. In this case, another computer-enabled participant may then add the user to ensure the integrity of the conference call roster. In an example, after the new attendee is added, all of the same functionality is available to them as with any other participant. So, if the added computer-less person provides an appropriate indication when they are speaking, e.g., presses a keystroke on another participant's computer, then the system can capture a voice sample and use it, assuming that it is of sufficient quality, to identify the speaker in the future.

Another control icon is the mute icon 818. The mute icon 818 allows the user to toggle their microphone on and off. In an example embodiment, when the mute icon 818 is enabled in a conference room, the whole room is muted and thus, no aural communication is provided to the other participants (e.g., conference rooms or individuals that have connected).

Another control icon that may be provided is the “I'm speaking” icon 820. In accordance with the methods 600 and 700 as described above, the “I'm speaking” icon 820 can be used to provide a manual indication of the current speaker. In an example, a user may use a mouse action to activate the “I'm speaking” icon 820 while the user is actively speaking. In an example, after a successful voice sample has been recorded, the “I'm speaking” icon 820 may be disabled in that particular user's interface. In an example, an icon similar to the “I'm speaking” icon, such as a “Participant is Speaking” icon (not shown) is only enabled when a participant is selected in the main window of the interface. This would allow a user to indicate when a non-computer user is speaking for voice sampling and semi-automatic conference room association. In other examples, an iconic user-interface control is located near each participant's name to provide an indication that the corresponding participant is the current speaker. The last control icon in this example is the exit icon 822.

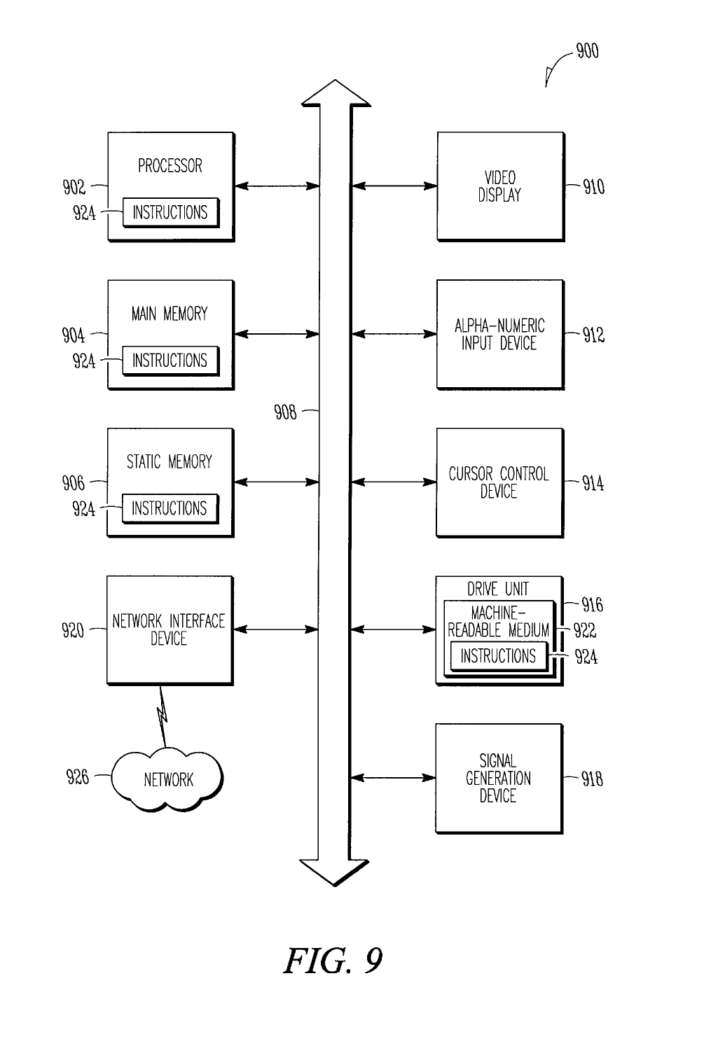

FIG. 9 illustrates a diagrammatic representation of a machine in the exemplary form of a computer system 900 within which a set or sequence of instructions, for causing the machine to perform any one of the methodologies discussed herein, may be executed. In alternative embodiments, the machine may comprise a computer, a network router, a network switch, a network bridge, Personal Digital Assistant (PDA), a cellular telephone, a web appliance, set-top box (STB) or any machine capable of executing a sequence of instructions that specify actions to be taken by that machine.

The computer system 900 includes a processor 902, a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920 to interface the computer system to a network 922.

The disk drive unit 916 includes a machine-readable medium 924 on which is stored a set of instructions or software 926 embodying any one, or all, of the methodologies described herein. The software 926 is also shown to reside, completely or at least partially, within the main memory 904 and/or within the processor 902. The software 926 may further be transmitted or received via the network interface device 920.

For the purposes of this specification, the term “machine-readable medium” shall be taken to include any medium which is capable of storing or encoding a sequence of instructions for execution by the machine and that cause the machine to perform any one of the methodologies of the inventive subject matter. The term “machine-readable medium” shall accordingly be taken to include, but not be limited to, solid-state memories, optical and magnetic disks, and carrier wave signals. Further, while the software is shown in FIG. 9 to reside within a single device, it will be appreciated that the software could be distributed across multiple machines or storage media, which may include the machine-readable medium.

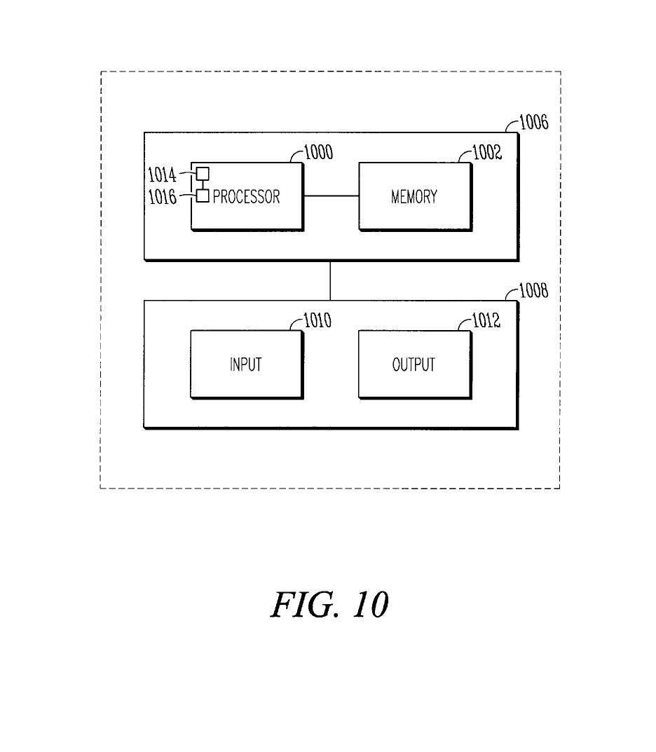

FIG. 10 illustrates portions of a system (e.g., a computer or client workstation 102, 106 or a network server 110 as illustrated in FIG. 1) that is capable of receiving and analyzing a voice sample. In one example, a processor 1000 is connected to interact with a memory 1002. A wide array of possible processor and memory combinations are available. Processors 1000 may include commercial units (e.g. Pentium, Motorola 68000 series, PowerPC) or specialized units made for use in specific applications. The memory 302 can include any memory, such as solid-state, magnetic, or optical media.

A user interface 1008 is typically connected to the processor-memory combination 1006. This user interface 1008 typically includes an input device 1010 and an output device 1012. The input device 1010 can be one or more of a keyboard, a mouse, a touchpad, a microphone, a sensing device, a monitoring device, or any other type of device that allows a computer to receive commands and input data from a user. The output device 1012 can include such things as a monitor, a printer, a speaker, or any other type of device that allows a system to represent resultant data to the user.

In one example, a voice sample is received by a sound capture module 1014. The sound capture module 1014 may optionally store the voice sample in the memory 1002. In some example embodiments, a voice analyzer module 1016 compares the voice sample stored in memory 1002 to other voice samples. The user interface 1008 may be adaptively updated depending on whether or not a match is found.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMS), read only memories (ROMs), and the like.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A computer-assisted method of organizing meeting participants comprising:
identifying a meeting participant;
determining whether the meeting participant is associated with a meeting location; and
if the meeting participant is associated with the meeting location, then providing an indication of the association on a computer display.

2. The method of claim 1, wherein the indication of the association includes at least one sub-roster related to one of a plurality of meeting locations.

3. The method of claim 1, wherein the indication of the association is a hierarchal tree display.

4. The method of claim 1, wherein the meeting location is a geographic location or a conference room.

5. The method of claim 1, wherein identifying the meeting participant comprises:
providing a login screen to the meeting participant;
receiving login information from the meeting participant; and
using the login information to determine the meeting participant's identity.

6. The method of claim 1, wherein identifying the meeting participant comprises:
receiving a voice sample of the meeting participant;
comparing characteristics of the voice sample to characteristics of one or more stored voice samples; and
if the comparison results in a match, then using the match to determine the meeting participant's identity.

7. The method of claim 1, wherein determining whether the meeting participant is associated with the meeting location comprises:
receiving location identification information from a meeting attendee; and
using the location identification information to determine the meeting participant's location.

8. The method of claim 7, wherein the location identification information is one of a vocal command, a keystroke, or a mouse action.

9. The method of claim 7, wherein the location identification information is an indication that a meeting participant is currently speaking and wherein using the location identification information comprises:
detecting a voice signal of the current speaker;
associating the voice signal with at least one voice channel; and
determining the location of the meeting participant using the corresponding voice channel.

10. The method of claim 10, wherein associating the voice signal with activity on the voice channel occurs only if the activity uniquely identifies the location.

11. The method of claim 1, wherein determining whether the meeting participant is associated with the meeting location comprises:
receiving an indication that the meeting participant is currently speaking;
detecting an active voice channel associated with the meeting participant's speech; and
using the active voice channel to determine a meeting participant's location.

12. The method of claim 11, wherein the indication that the meeting participant is currently speaking is one of a vocal command, a keystroke, or a mouse action.

13. The method of claim 11, wherein the indication that the meeting participant is currently speaking is provided by the meeting participant.

14. The method of claim 11, wherein the indication that a meeting participant is currently speaking is provided by another meeting participant.

15. The method of claim 11, wherein using the voice channel only occurs if the active speaker can be unambiguously associated with the meeting location.

16. The method of claim 1, comprising:
receiving voice data;
determining if the voice data matches voice data of a current meeting participant; and
if there is a match, indicating a speaking meeting participant on the computer display.

17. A computer-assisted method of identifying an actively speaking participant in conference comprising:
receiving an indication that a meeting participant is currently speaking;
recording voice characteristics of an active voice channel;
associating the recorded voice characteristics with the meeting participant;
matching voice characteristics of subsequent active voice channels against the recorded voice characteristics; and
displaying an indication of the identity of the meeting participant as the active speaker using the results of the matches.

18. The method of claim 17, wherein the indication that a meeting participant is currently speaking is provided by another meeting participant.

19. The method of claim 17, wherein the recording of voice characteristics only occurs if there is an unambiguous active voice channel.

20. The method of claim 17, wherein the recording of voice characteristics only occurs if the voice characteristics are sufficiently distinctive.

21. The method of claim 17, comprising displaying an active location using the active voice channel.

22. The method of claim 21, wherein displaying the active location only occurs if the active voice channel uniquely identifies a location.

23. A computer-readable medium including instructions that, when performed by a computer, cause the computer to:
identify a meeting participant;
determine whether the meeting participant is associated with a meeting location; and
if the meeting participant is associated with the meeting location, then provide an indication of the association on a computer display.

24. The computer-readable medium of claim 23, wherein the indication of the association includes at least one sub-roster related to one of a plurality of meeting locations.

25. The computer-readable medium of claim 23, wherein the indication of the association is a hierarchal tree display.

26. The computer-readable medium of claim 23, wherein the meeting location is a geographic location or a conference room.

27. The computer-readable medium of claim 23, wherein the instructions for identifying the meeting participant cause the computer to:
receive a voice sample of the meeting participant;
compare characteristics of the voice sample to characteristics of one or more stored voice samples; and
if the comparison results in a match, then use the match to determine the meeting participant's identity.

28. The computer-readable medium of claim 23, wherein the instructions for determining whether the meeting participant is associated with the meeting location cause the computer to:
receive location identification information from a meeting attendee; and
use the location identification information to determine the meeting participant's location.

29. The computer-readable medium of claim 28, wherein the location identification information is one of a vocal command, a keystroke, or a mouse action.

30. The computer-readable medium of claim 28, wherein the location identification information is an indication that a meeting participant is currently speaking and wherein the instructions for using the location identification information cause the computer to:
detect a voice signal of the current speaker;
associate the voice signal with at least one voice channel; and
determine the location of the meeting participant using the corresponding voice channel.

31. The computer-readable medium of claim 23, wherein the instructions for determining whether the meeting participant is associated with the meeting location cause the computer to:
receive an indication that the meeting participant is currently speaking;
detect an active voice channel associated with the meeting participant's speech; and
use the active voice channel to determine a meeting participant's location.

32. The computer-readable medium of claim 23, comprising instructions that cause the computer to:
receive a voice data;
determine if the voice data matches a voice data of a current meeting participant; and
if there is a match, indicate a speaking meeting participant on the computer display.

33. A computer-readable medium including instructions that, when performed by a computer, cause the computer to:
receive an indication that a meeting participant is currently speaking;
record voice characteristics of an active voice channel;
associate the recorded voice characteristics with the meeting participant;
match voice characteristics of subsequent active voice channels against the recorded voice characteristics; and
display an indication of the identity of the meeting participant as the active speaker using the results of the matches.

34. The computer-readable medium of claim 33, wherein the indication that a meeting participant is currently speaking is provided by another meeting participant.

35. The computer-readable medium of claim 33, wherein the recording of voice characteristics only occurs if there is an unambiguous active voice channel.

36. The computer-readable medium of claim 33, wherein the recording of voice characteristics only occurs if the voice characteristics are sufficiently distinctive.

37. The computer-readable medium of claim 33, comprising instructions to display an active location using the active voice channel.

38. The computer-readable medium of claim 37, wherein the instructions to display the active location only occur if the active voice channel uniquely identifies a location.

39. A system for organizing meeting participants comprising:
a processor coupled to a memory;
a user interface coupled to the processor;
a sound capture module to run on the processor to receive and store a voice print; and
a display module to run on the processor to update the user interface related to the captured voice print, wherein the update to the user interface includes arranging an indication of a meeting participant associated with the voice print to correspond with the meeting participant's location.

40. The system of claim 39, comprising:
a sound analyzer module to run on the processor to determine if the captured voice print's quality is sufficient to allow voice matching.

41. A system for organizing meeting participants comprising:
one or more conference end points; and
one or more hubs communicatively coupled to the one or more conference endpoints, wherein each hub includes:
a processor;
a sound capture module to run on the processor to receive and store a voice print from the one or more conference end points; and
an output module to run on the processor to deliver an indication a location of a meeting participant associated with the voice print to the one or more conference endpoints.

42. The system of claim 41, the one or more hubs comprising:
a sound analyzer module to run on the processor to determine if the captured voice print's quality is sufficient to allow voice matching.

43. The system of claim 41, wherein the conference end point is one of a microphone, a video conference station, a telephonic device, or a computer.
